(19) United States
(12) Patent Application Publication
(10) Pub. No.: US 2014/0018060 A1
(43) Pub. Date: Jan. 16, 2014

(54) Remote control app for smart phones

(71) Applicants: Edward F. Tuck, West Covina, CA (US); Douglas R. Sallen, Monterey, CA (US)

(72) Inventors: Edward F. Tuck, West Covina, CA (US); Douglas R. Sallen, Monterey, CA (US)

(21) Appl. No.: 13/507,642

(22) Filed: Jul. 12, 2012

(51) Int. Cl. H04W 4/00

(52) U.S. Cl. CPC H04W 4/008
USPC 455/420

(57) ABSTRACT

Methods and apparatus for a Remote Control App for Smart Phones are disclosed. One embodiment of the present invention is a software application or “App” which may be downloaded to a conventional smart phone. Once downloaded to the smart phone and to a remote computer, network or other information appliance, the smart phone may be used to operate and/or control the remote computer, network or other information appliance.

### CROSS-REFERENCE TO RELATED PATENT APPLICATIONS, CLAIMS FOR PRIORITY & INCORPORATION BY REFERENCE

The Present Continuation-in-Part Patent Application is related to U.S. Provisional Patent Application U.S. Ser. No. 60/005,640, filed on 5 Dec. 2007 and to U.S. Non-Provisional Patent Application U.S. Ser. No. 12/315,367, filed on 1 Dec. 2008. The Applicants hereby claim the benefit of priority under Sections 119 and/or 120 of Title 35 of the United States Code of Laws for any subject matter which is commonly disclosed in the Present Continuation-in-Part Application and in the Provisional and Non-Provisional Applications identified in this paragraph.

The Applicants hereby incorporate all the text and drawings of U.S. Ser. No. 12/315,367 into the present Continuation-in-Part Patent Application.

The text and drawings of U.S. Ser. No. 12/455,963, which is shown in U.S. Patent Publication Number 2010/013 4247, and which was published on 3 Jun. 2010, is hereby incorporated by reference.

The text and drawings which describe the RainBarrel^{SM} Method, as shown in U.S. Patent Application Number 2002/004 2919, is also incorporated by reference.

The text and drawings which describe the UltraSecure^{SM} System, as shown in U.S. patent application Ser. No. 09/887,570, filed on 22 Jun. 2001, and in PCT International Patent Application No. PCT/GB02/05612, filed on 11 Dec. 2002, are also incorporated by reference.

### FIELD OF THE INVENTION

The present invention pertains to methods and apparatus for a Remote Control App for Smart Phone. One embodiment of the present invention is a software application or “App” which may be downloaded to a conventional smart phone. Once downloaded to the smart phone and to a remote computer, network or other information appliance, the smart phone may be used to operate and/or control the remote computer, network or other information appliance.

### BACKGROUND OF THE INVENTION

Recent forecasts indicate that by the year 2015, 1.7 billion smart phones will be sold worldwide. In general, currently available or “conventional” smart phones are currently used to make telephone calls, to surf the Internet, to check e-mail, to play games or to enjoy content.

No device or software that is currently available offers the ability to convert a conventional smart phone to a remote control for computers or other information devices.

The development of a device or software that would offer these capabilities would constitute a major technological advance, and would satisfy long felt needs and aspirations in the computing, entertainment and telecommunications businesses.

### SUMMARY OF THE INVENTION

One embodiment of the invention provides a method for adding computing functionality to a conventional smart phone. The smart phone includes a central processing unit, or CPU. The CPU includes a non-volatile memory such as a solid state drive. This non-volatile memory is divided into a number of dynamic partitions, and each dynamic partition is assigned to a persona. A user's digital identity comprises one or more personas. Each persona may pertain to a different type of stored information or files, such as music, videos, books, documents or spreadsheets. Each of the dynamic partitions is protected by one or more access rules. When a group of smart phones is used in combination by a family, company or other organization, these access rules may be set by a group administrator. Access to personas within the group may also be determined by the group administrator.

The smart phone also includes a dynamic memory, a long range radio, and a short range radio. In one embodiment, these are random access memory, a cellular telephone radio and a BlueTooth radio.

A remote transmitter is connected to a server. The server includes a memory for storing an App. The App is conveyed from said server to the transmitter. The App is downloaded to the smart phone from the transmitter using the long range radio. The App is stored in the non-volatile memory of the smart phone. The App runs on the CPU of the smart phone. The App is then downloaded or transferred to a separate information appliance. The smart phone and the App are then used in combination to control the functions of the separate nearby information appliance using the short range radio.

An appreciation of the other aims and objectives of the present invention, and a more complete and comprehensive understanding of this invention, may be obtained by studying the following description of preferred and alternative embodiments, and by referring to the accompanying drawings.

### A BRIEF DESCRIPTION OF THE DRAWINGS

FIG. 1 is a schematic diagram which shows the download of a software application or “App” to a conventional smart phone from a wireless transmitter.

FIG. 2 is a second diagram, illustrating that the App is downloaded into the memory of the smart phone, and changes the state of the smart phone by enhancing its functions and capabilities.

FIG. 3 is a third diagram that reveals how the combination of the conventional smart phone and the downloaded App enable a user to control a computer, data environment or information appliance.

FIG. 4 is a perspective view of an after-market sleeve that may be used to envelop a conventional smart phone. The sleeve may provide additional memory and/or battery power for the smart phone.

FIG. 5 portrays an additional feature of the invention which provides restricted use based upon the GPS-derived location of the smart phone.

FIG. 6 offers a schematic view of an alternative embodiment of the invention, which provides “on-the-fly” communications with “unfriendly” information appliances.

FIG. 7 depicts one embodiment of the invention, which provides the user with a “Cloud in the pocket.”

FIG. 8 illustrates another embodiment of the invention, which provides “Cloud insurance.”

FIG. 9 offers a view of another embodiment of the invention, which supplies a method for replacing a lost or stolen smart phone. In one embodiment of the invention, the replacement device may already carry the operating system, software applications, data, files, content and information that were stored on the lost device.

FIG. 10 is a schematic block diagrams which illustrates the method steps which specify one embodiment of the invention.

FIG. 11 provides an illustration of how a family uses one embodiment of the present invention.

FIG. 12 shows each member of the family, together with their family digital identities. The digital identities comprise a number of personas.

FIG. 13 depicts one digital identity as a pie chart, which is divided into partitions or personas.

FIG. 14 explains access rules for partitions.

FIG. 15 shows how the manager and employees of a company may use one embodiment of the present invention.

FIG. 16 shows how the Group Administrator defines the partitions on the information appliances of each member of the company.

FIG. 17 furnishes a view of the Manager viewing the partitions on an employee's smart phone.

FIG. 18 shows how the present invention may be used by a number of employees to work together as a team.

FIG. 19 reveals the process for generating a report by drawing upon the contents of multiple partitions.

### A DETAILED DESCRIPTION OF PREFERRED AND ALTERNATIVE EMBODIMENTS

### I. Overview of the Invention

One embodiment of the present invention combines a conventional smart phone with a downloadable software application or “App”. This combination enables a user to control and/or operate a computer or some other information appliance using the smart phone.

In this Specification and in the Claims that follow, the term “smart phone” refers to any currently-available, portable, wireless device, appliance or component which is used for communications, Internet or e-mail access, gaming or the viewing of content. The term “App” pertains to a software program which may be downloaded over a wired or wireless connection to a smart phone, and then stored in the smart phone memory. The App may also be transferred to one or more computers or other information appliances via a wired or wireless transmission. The terms “computer” and “information appliance” are intended to pertain to any device, system, or network which is physically separate from the smart phone which is used to process information, communications, data or content. The term “Cloud” refers to any aggregation of hardware, systems, components and/or software that comprises a local or remote network.

### II. Downloading the App

In one embodiment of the invention, a user obtains a conventional smart phone, and then visits a website running on a remote server. The user opens an account on the website, and downloads the App to his or her smart phone over a wireless connection. This wireless connection may be a transmission from a cellular telephone network, a Wi-Fi or WiMax network, a Bluetooth® link or any other suitable wireless pathway. In an alternative embodiment, the user may download the App over a cable connected to a computer that has the App stored in its memory.

Once the App is stored in the non-volatile memory of the smart phone. The download of the App to the smart phone changes the state of the smart phone, and now enables the smart phone to perform functions that it previously could not perform.

After the App is downloaded, the user then downloads the same or a related App to one or more personal computers or information appliances. The download is stored in the non-volatile memory of the computer or information appliance. This download changes the state of the computer or information appliance. The personal computer or information appliance is now able to be controlled by the smart phone which runs the same App. Once the App is present on another of the user's computers or devices, that computer or device becomes a “friendly” device which is capable of operating in cooperation with the smart phone.

Depending on the capacity of the platform, the App may require that the platform on which it is installed be augmented by the addition of an operating system (OS). This OS may be loaded into the platform's memory from a web site, or from an external memory device. Alternatively, the OS can remain on the memory device or website, server or other storage device or medium which is connected either physically (as with a USB connector) or wirelessly, and carry out its function in situ.

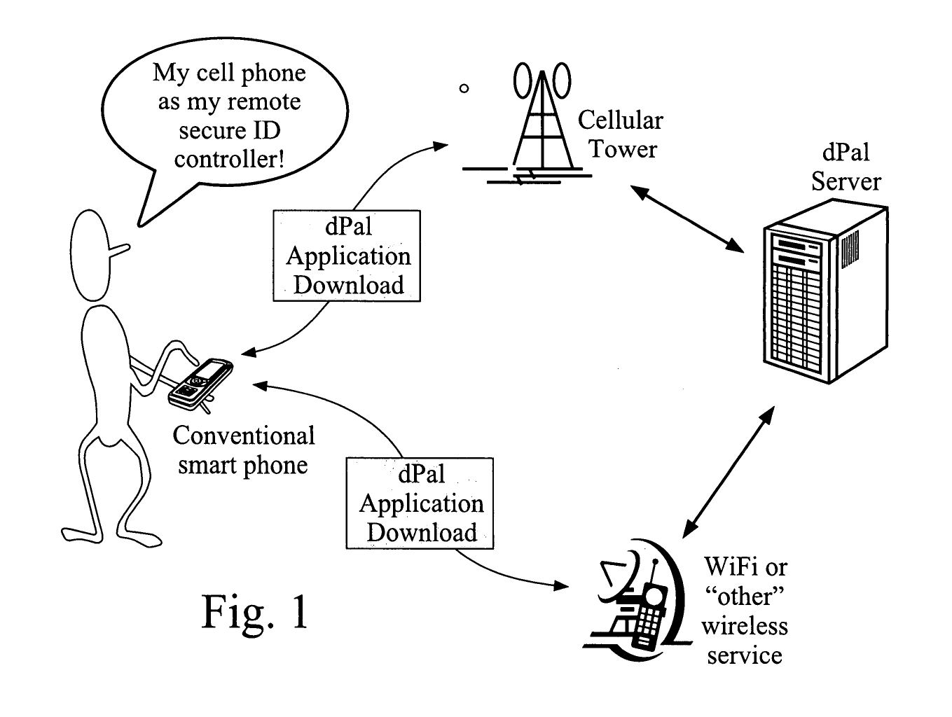

FIG. 1 shows the App being downloaded from a cellular phone tower or from a Wi-Fi transmitter. Both of these transmitters are connected to a remote server that stores the App in its memory.

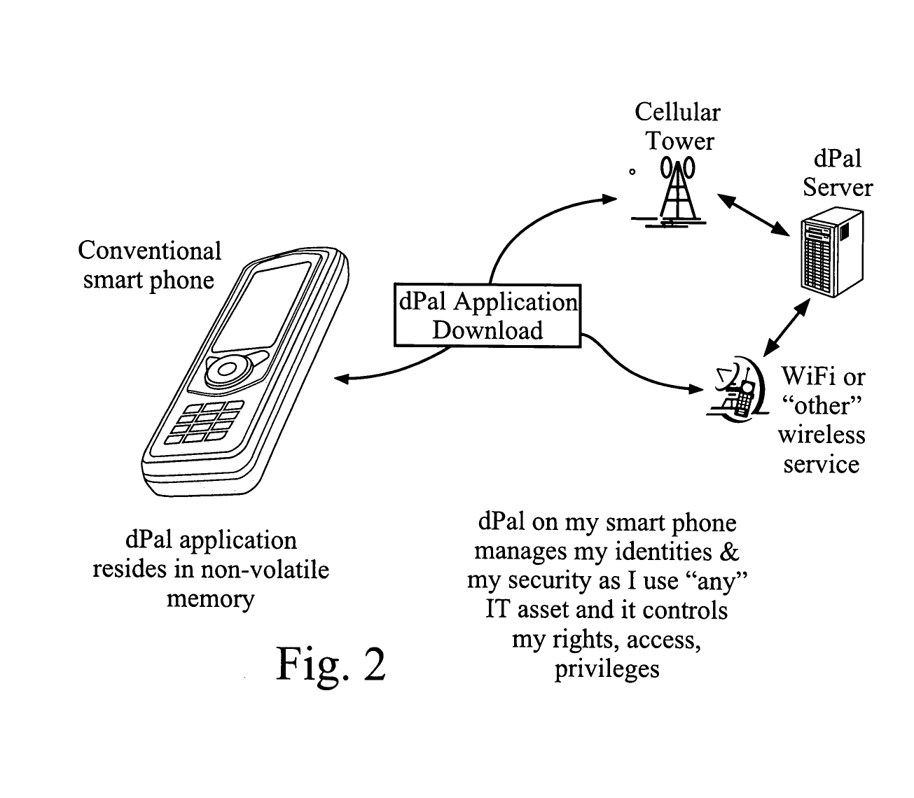

FIG. 2 depicts the wireless reception of the App, and the storage of the App in the memory of the smart phone.

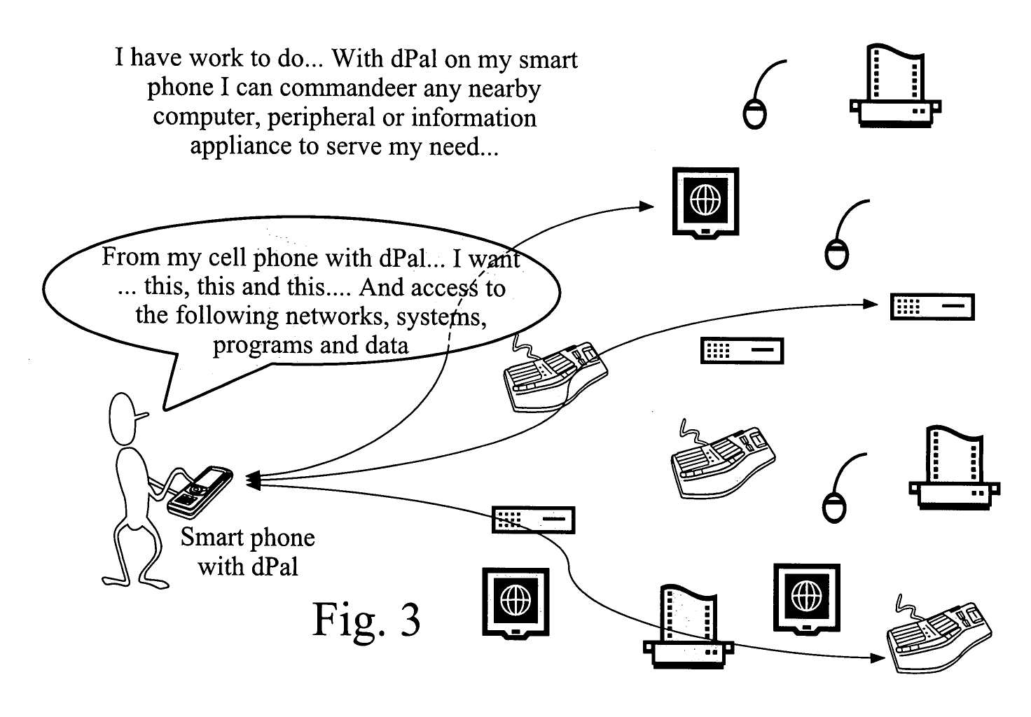

FIG. 3 illustrates a user who is now able to control his personal computer using the combination of the smart phone and the App.

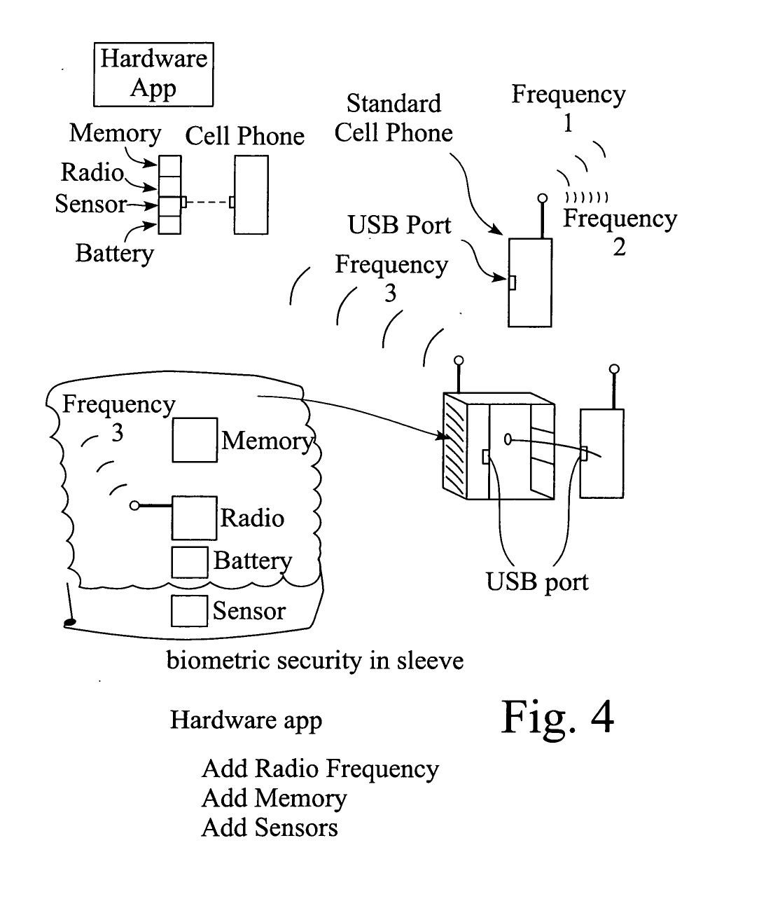

FIG. 4 supplies a view of an after-market sleeve that may be used to envelop a conventional smart phone. The sleeve may provide additional memory and or battery power for the smart phone.

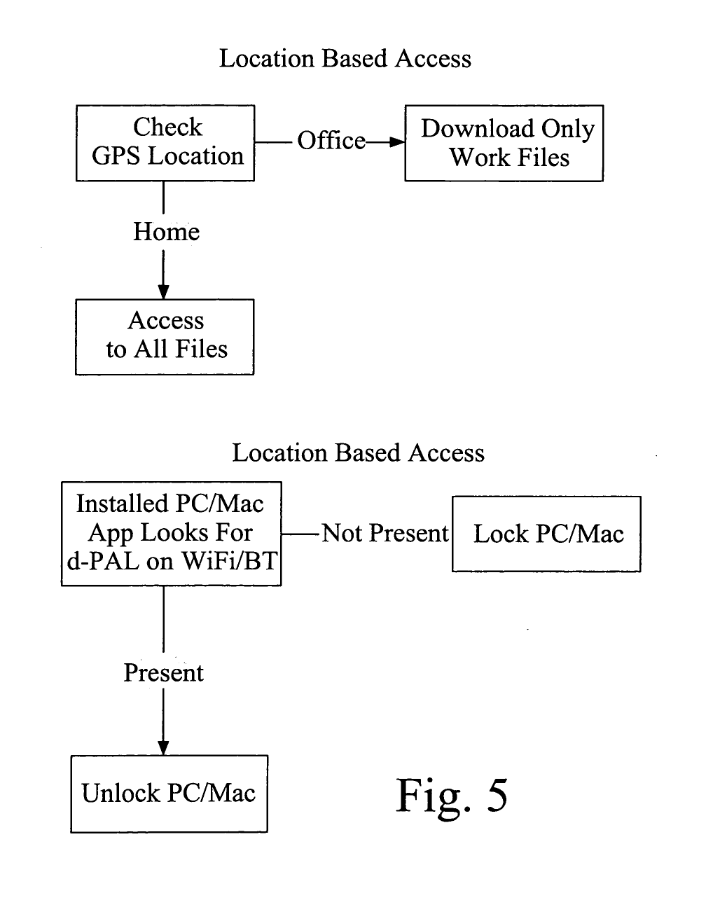

FIG. 5 portrays an additional feature of the invention which provides restricted use based upon the GPS-derived location of the smart phone.

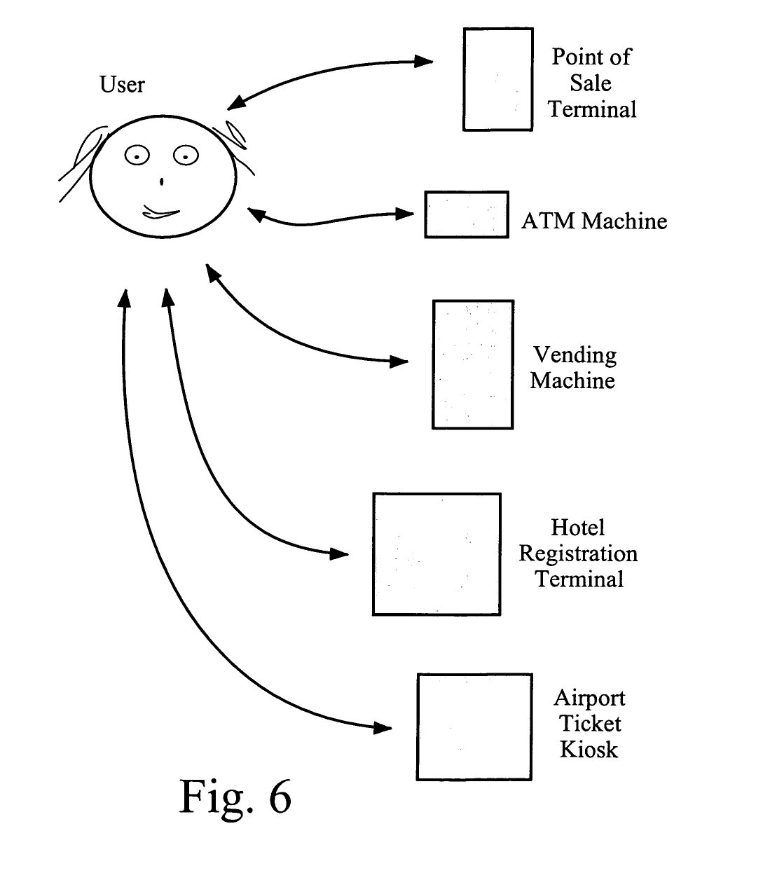

FIG. 6 offers a schematic view of an alternative embodiment of the invention, which provides “on-the-fly” communications with “unfriendly” information appliances.

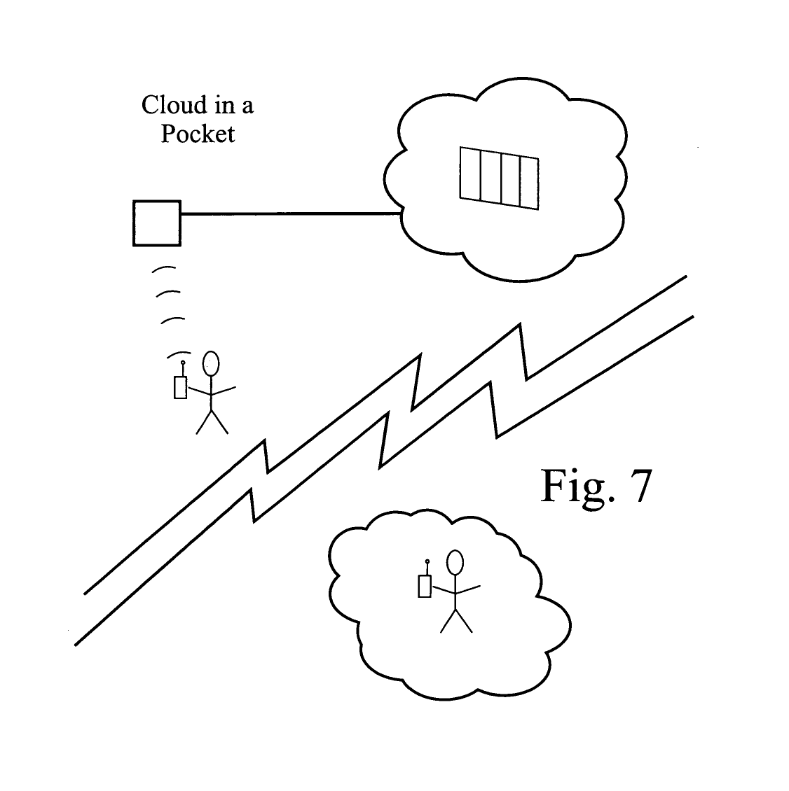

FIG. 7 depicts one embodiment of the invention, which provides the user with a “Cloud in the pocket.” Once the App is downloaded, the smart phone offers capabilities which were not previously available to the user. As an example, the user need not depend upon the Cloud for software applications, data or content, since all of these may be stored securely in his or her own smart phone. The improved smart phone essentially becomes the Cloud in the user's pocket.

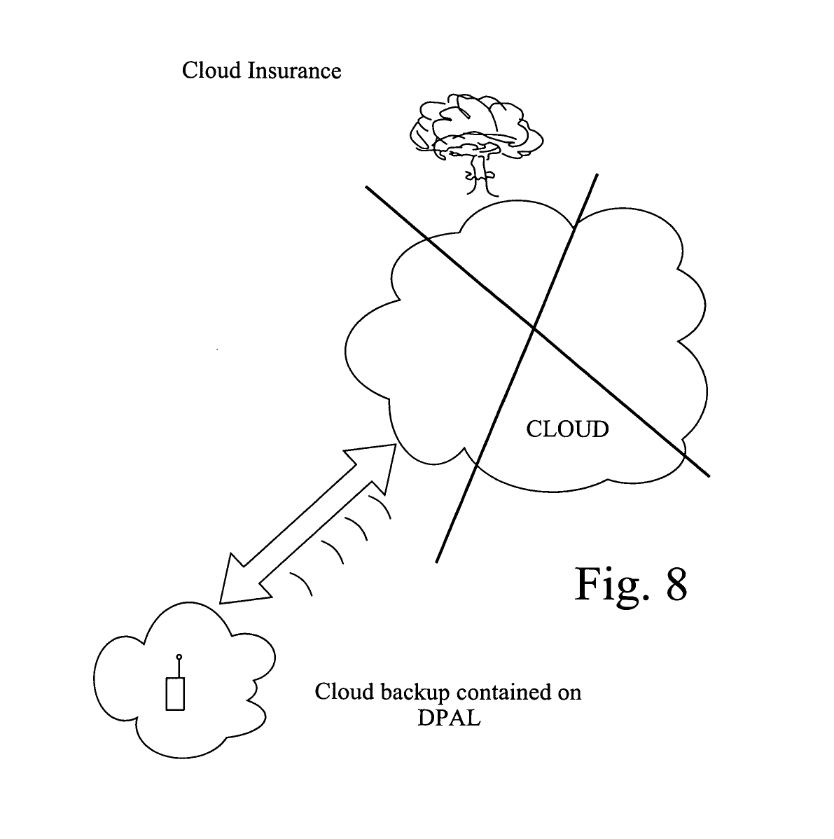

FIG. 8 illustrates another embodiment of the invention, which provides “Cloud insurance.” If an Internet connection is not available, or if some problem disables a remote server where data or files may be stored, the user is able to rely upon the operating system, software applications, data, files and content stored in his or her smart phone.

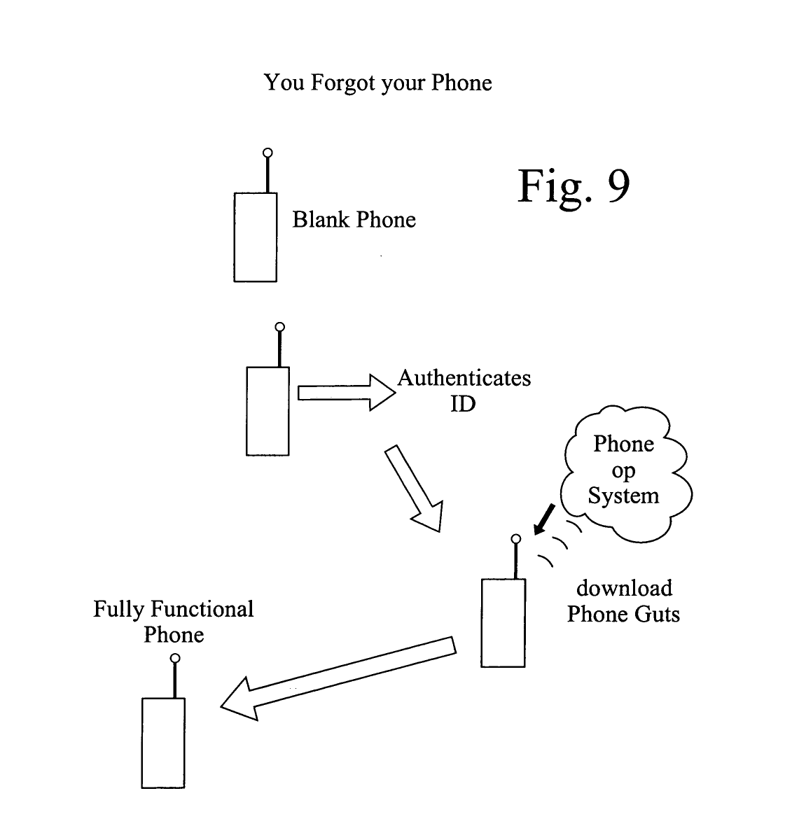

FIG. 9 offers a view of another embodiment of the invention, which supplies a method for replacing a lost or stolen smart phone. In one embodiment of the invention, the replacement device may already carry the operating system, software applications, data, files, content and information that were stored on the lost device.

In one embodiment of the invention, the smart phone is backed-up to one of the user's other friendly devices. The smart phone may be continuously backed-up as data, files and/or content on the smart phone changes. In this embodiment, a replacement for a lost or stolen smart phone may be created by obtaining a new smart phone, and then downloading the back-up copy of data, files and/or content from a friendly device.

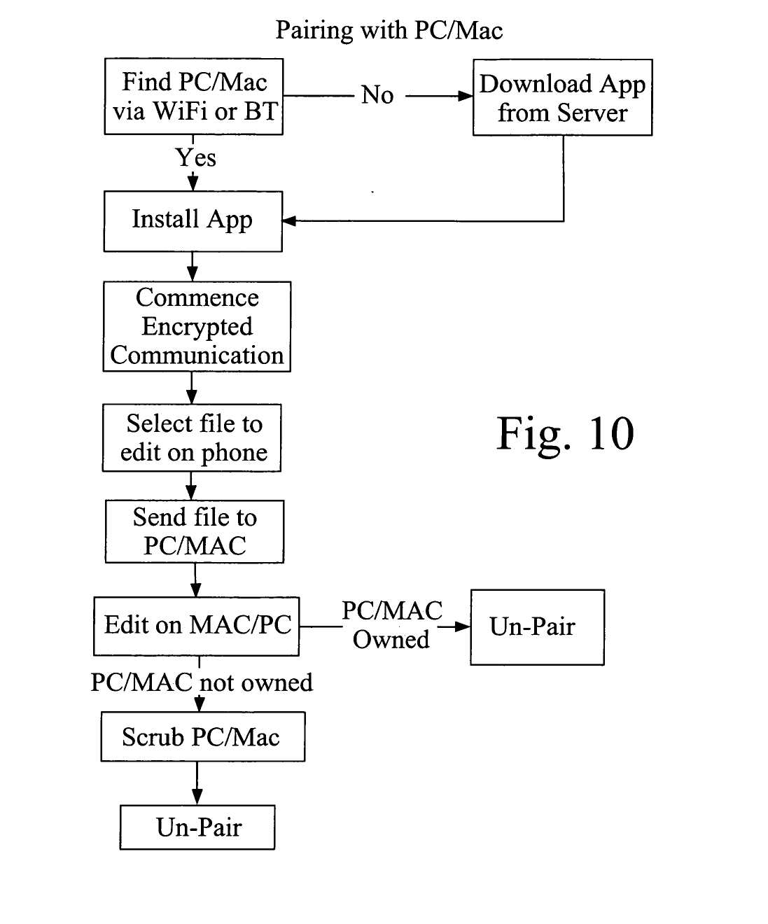

FIG. 10 is a schematic block diagrams which illustrates the method steps which specify one embodiment of the invention.

### III. Building a Master Library

In one embodiment of the invention, a master library is created and maintained in the user's smart phone. The master library may contain data, files, records, content, preferences, or any other information that is capable of being stored in the memory of the smart phone.

This embodiment provides the user with a convenient method of maintaining a single master library, eliminating the need for synchronizing or updating other computers or information appliances. This embodiment also eliminates the need for using remote access to a home or office computer, or to the Cloud.

In one embodiment of the invention, the master library on the user's smart phone is saved each time the smart phone communicates with a friendly computer or information appliance. To save bandwidth and power, only the portions of the master library which have changed since the previous update need to be recorded.

In another embodiment, the data which had been stored in a lost or stolen smart phone may be easily restored on a replacement smart phone by transferring a back-up copy of the Master Library from a friendly computer to the new smart phone.

The term “friendly” is used to denote a remote or separate network or device which has been “properly introduced” to the smart phone. In one embodiment of the invention, the smart phone is only able to operate or control this separate network or device after an initial conversation has occurred between the smart phone and the separate network or device. This initial conversation establishes the terms and conditions of the subsequent interactions, and also establishes and certifies a level of trust between the smart phone and the separate network or device.

### IV. Digital Identity & Personas

In one embodiment of the invention, the total digital record or presence of an individual comprises that person's “Digital Identity.” A Digital Identity includes all a person's digital files, data, content or other information that is owned, possessed by or stored on behalf of that person. The portion of a person's Digital Identity which is available on the Internet is referred to as that individual's “Web Identity.”

In one embodiment of the invention, a Digital Identity comprises one or more “Personas.” A Persona is a segment, portion or part of a Digital Identity. A Persona is created by “partitioning” the memory or other storage facility which is owned, controlled or maintained by the individual, or by another on behalf of the individual. The verb “partitioning” describes the process or method of making, forming, defining, setting, adjusting or erasing a partition or persona. Partitions may be “Dynamic Partitions” if they are capable of being altered, changed or deleted. Each partition may be further divided into “sub-partitions.”

The data, files and content stored in each partition is accessed in accordance with different access rules. As an example, access to a specific partition may require a particular password. In more complex embodiments, their may be many access rules for a partition. These access rules insure the safe access and control of all the smart phones used by each of the members of the family, and supplies an easily usable process for safe computing.

### V. An Example of Basic Uses of the Invention

Once the App is downloaded to a smart phone, and after the App has also been downloaded to a friendly other device, the user may operate the friendly other device using the smart phone. The user may control the other friendly device by utilizing the touch screen of the smart phone, by finger gestures that are interpreted by a sensor on the smart phone or by using voice commands which are interpreted by software programs such as Dragon Naturally Speaking^{SM} or Siri^{SM}.

The invention allows many different users to safely and easily access and control their files, data and content. In one example, a worker may replace his or her laptop with the present invention. Since the worker has a computer at home and a computer at work, he or she may use a smart phone with the App instead of carrying a laptop. In another example, a student may carry all of his or her textbooks, educational materials and homework assignments on a smart phone, and then use a friendly computer at home and at school to view files, data and content.

### IV. An Example of Digital Identities & Personas for a Family

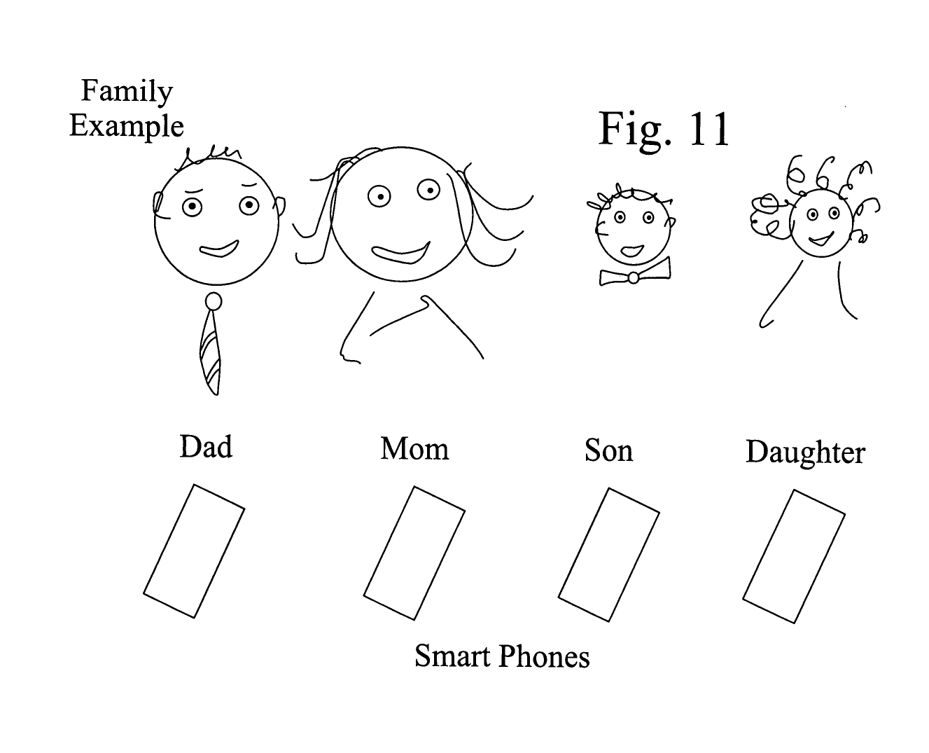

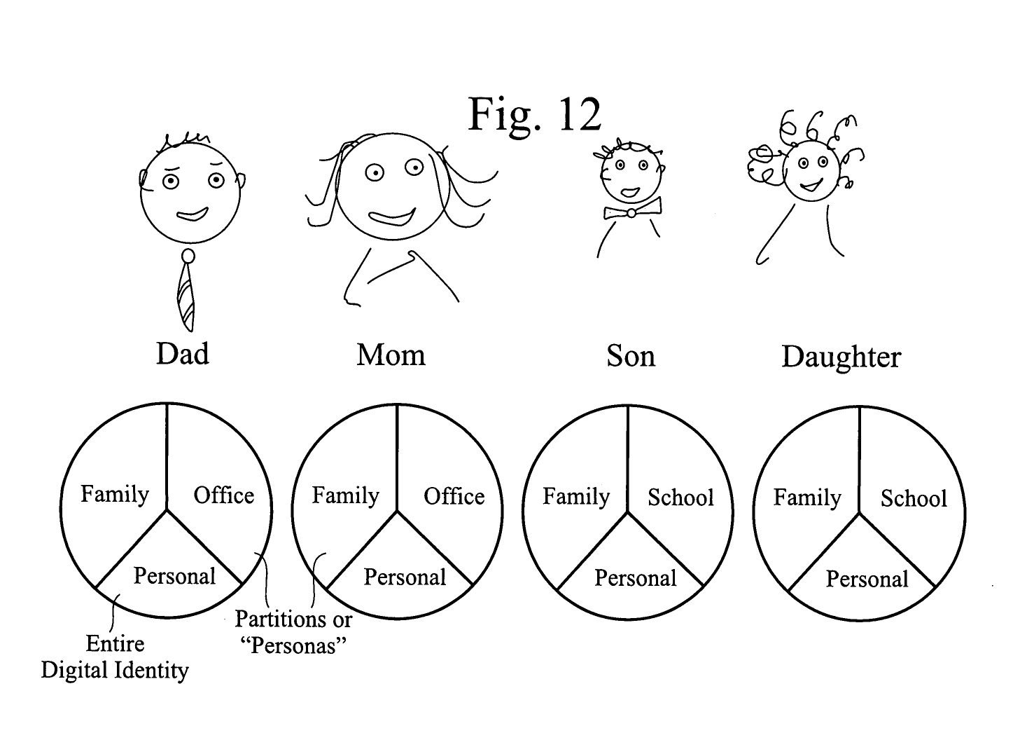

In one example, family of four each has a conventional smart phone. The present invention, the Remote Control App for Smart Phones, is downloaded and stored on each of this group of four smart phones. Each member of the family: Dad, Mom, Son and Daughter, has one of the smart phones that operates the App. This group is illustrated in FIG. 11. One of the members of the family is appointed as the Group Administrator. In this example, the Group Administrator is Dad. The Group Administrator defines, sets and names the partitions or personas for each of the four smart phones in this group. The Group Administrator has access to each of the four smart phones. The Group Administrator may have unrestricted access to every partition on every smart phone, or may have only limited or no access to some partitions, as shown in FIG. 12.

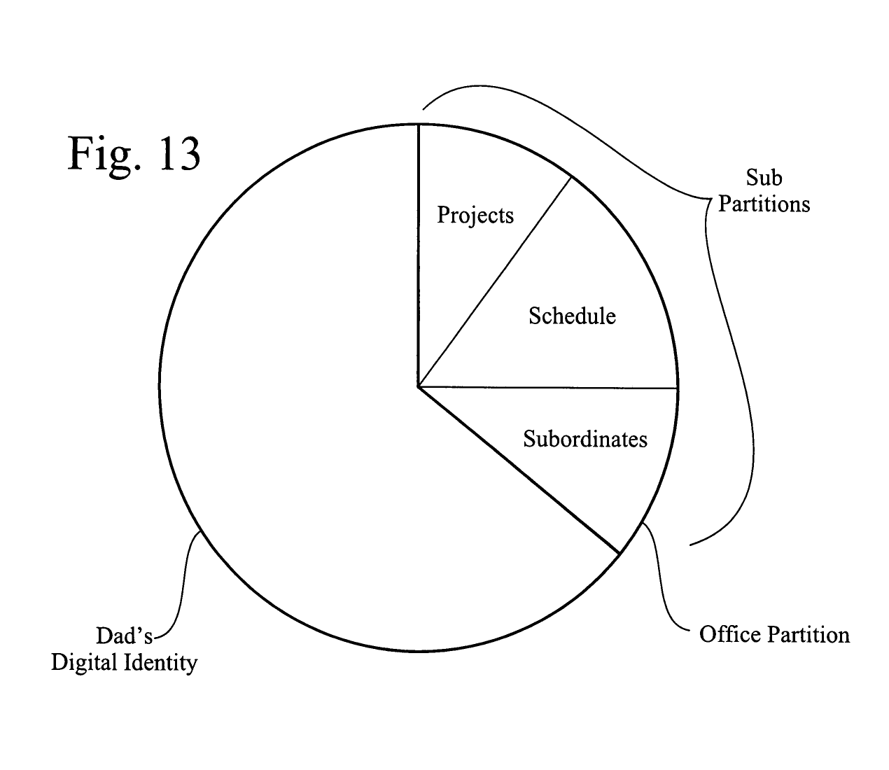

In one example, the memory in each smart phone in this group is divided into three partitions, as shown in FIG. 13, and as explained in the following table:

Smart Phone

| | | | |
|---|---|---|---|
| Dad | Mom | Son | Daughter |

Partitions

| | | | |
|---|---|---|---|
| Family | Family | Family | Family |
| Office | Office | School | School |
| Personal | Personal | Personal | Personal |

The “Family” partition includes information that is shared by all the members of this group. It may include schedules, events, birthdays, anniversaries and “to-do” lists for each individual. The “Office” and “School” partitions are reserved for information regarding Mom and Dad's jobs, and Son and Daughter's school schedule, texts, homework assignments and other education-related activities. The “Personal” partitions are maintained for information, content or files that is particular to each user. The Personal partitions might include links to favorite websites, subscriptions to periodicals, book, movies, videos and music.

In this example, the Group Administrator has unlimited access to the first and second partitions on each smart phone in the group. The third partition on Dad and Mom's smart phone may be accessed only by the owner of each smart phone. The “Personal” partitions for Son and Daughter are accessible by their respective owners, but are also limited by parental controls which excludes the download of certain types of content. In this Specification, and in the Claims that follow, the term “access” pertains to the processes of reading, writing, altering, viewing, measuring, controlling, monitoring, manipulating, using, analyzing, erasing or otherwise interacting with data, content, files or information which is stored, held or present in a partition.

In this example, all of the data, files, content or other information stored on each smart phone is considered to be the total and complete Digital Identity for each individual. The Group Administrator may add new partitions, may vary the size of the partitions, or may delete partitions. Each individual in the group may create sub-partitions in each partition. For example, Dad's Office Partition may comprise three sub-partitions: Projects, Schedule and Subordinates. Daughter's School Partition may comprise: Courses, Schedule and Homework.

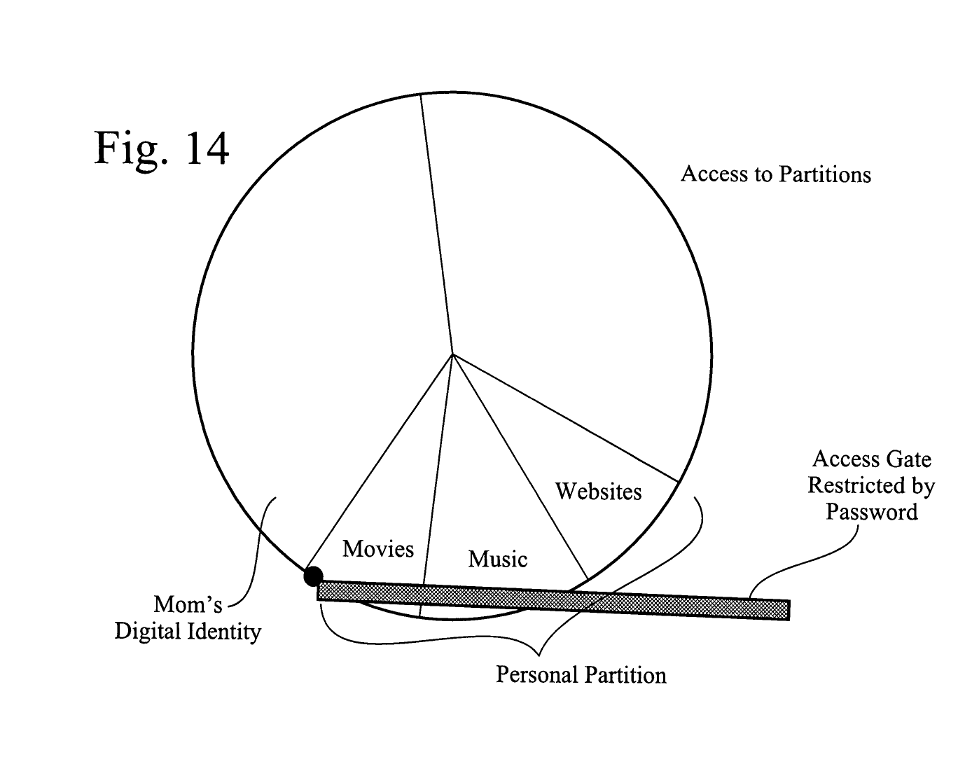

Each partition, or sub-partition, may be governed by one or more access rules, as shown in FIG. 14. An access rule is a protocol, principle, condition or standard which governs or regulates the ability of the Group Administrator or another authorized user to read, write, alter, view, measure, control, monitor, manipulate, use, analyze, erase or otherwise interact with data, content, files or information which is stored, held or present in a partition. An access rule may be considered to be a key to a lock which guards the door to each partition.

As an example, access to Mom's Personal Partition requires a password known only to Mom. Many different access rules may be used as keys to partitions. An access rule may be based on the user's password, finger print, voice print, retina analysis or physical location. Other access rules may pertain to security clearances, permitted time of access, rank, office, group membership or some other affiliation or status.

### VII. A Graphical User Interface for Viewing and Managing Digital Identities & Personas in a Company

In another example, the present invention offers a graphical user interface for viewing and managing digital identities and personas in a company or organization. The term “organization” is intended to encompass any collection or group of individuals, including institutions, societies, businesses, trading partners, government agencies, military units, non-profit groups, non-commercial organizations, clubs or other affiliated parties.

The graphical user interface is generated by a software program which runs on a local or remote server. Each smart phone is used to communicate with this server via a wired or wireless connection.

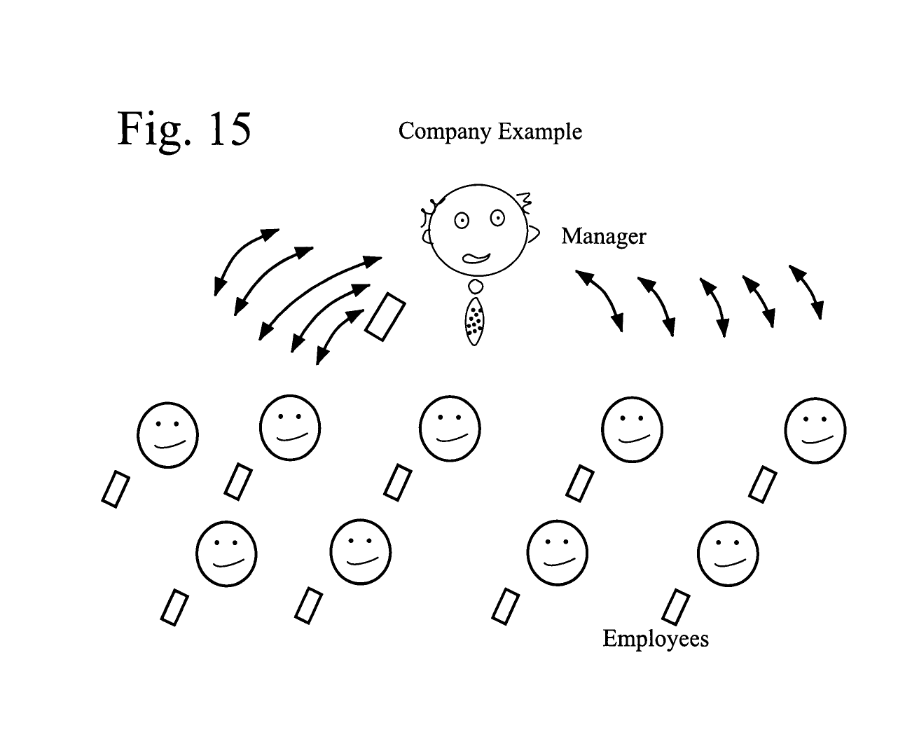

As shown in FIG. 15, a company comprises a Manager and nine employees. The Manager and the employees each have a conventional smart phone. The present invention, the Remote Control App for Smart Phones, has been downloaded to the memory in each smart phone, and changes the state of the smart phone so that it provides new functions and capabilities to each user.

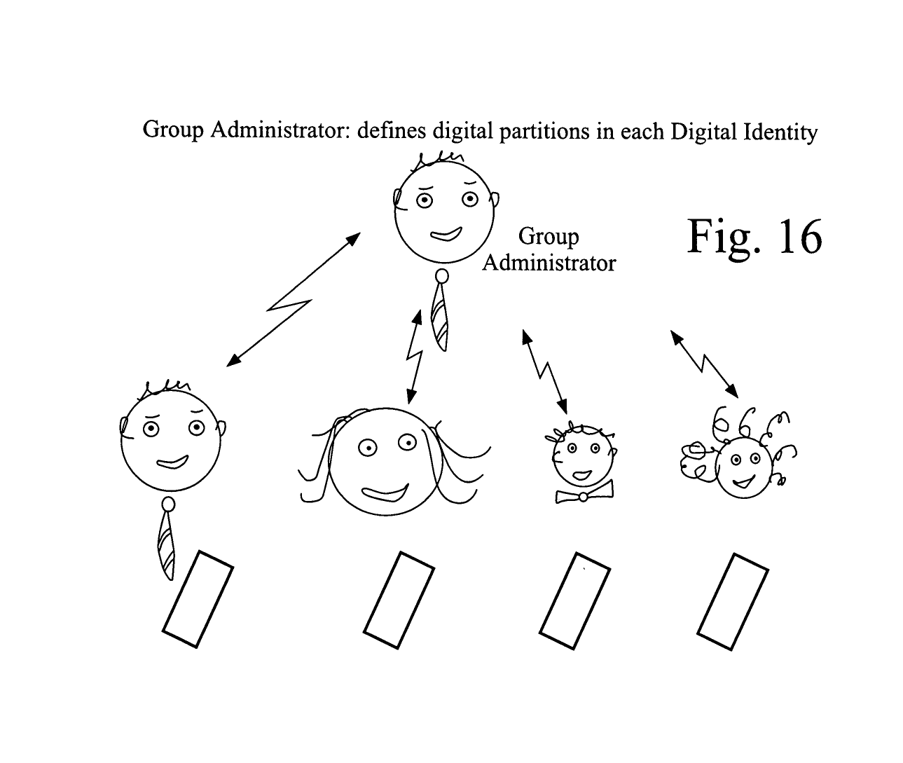

In this example, the Manager is the Company Group Administrator. All the operations of all the smart phones in the group are based on his sole discretion and direction. The company owns all the smart phones, and all the information stored on all the smart phones. In this particular example, the Manager has the right to control and to access all the partitions of each smart phone in the group, as shown in FIG. 16. In accordance with the present invention, the Company Group Administrator has the “keys” to all the partitions on all the smart phones used and operated by himself and his employees. Each employee has access to all of his or her partitions. Other employees may have access to another employees partitions, based on access rules determined by the Manager. Consultants, vendors, creditors, customers and other persons outside the organization may also be granted access to some of the partitions maintained on Company smart phones.

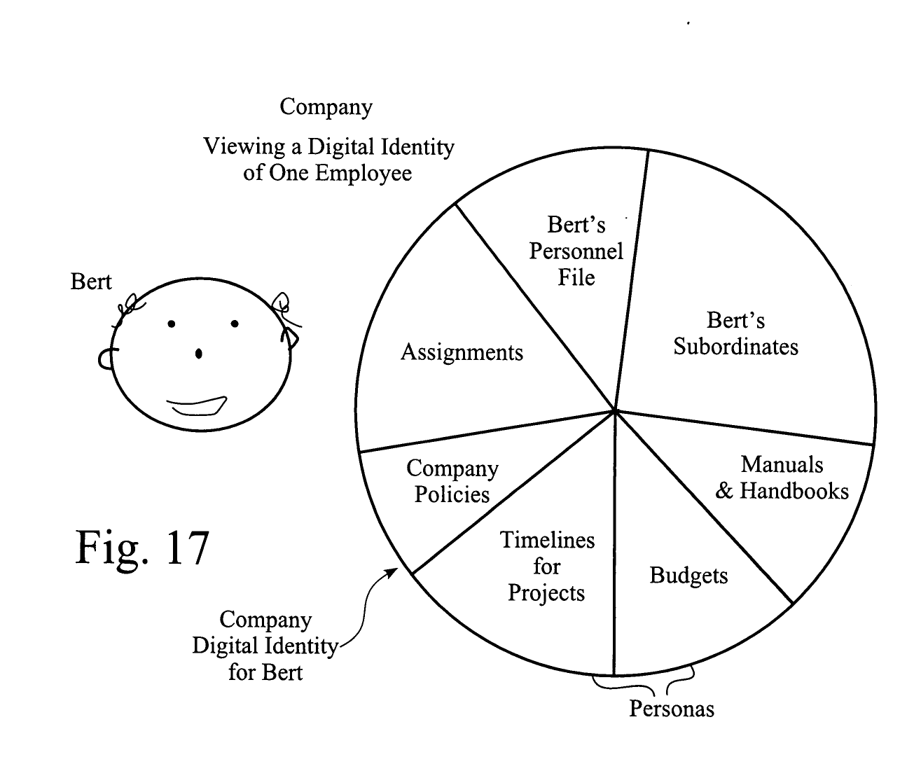

FIG. 17 shows how the Manager may easily view and interact with the different personas stored on one of the smart phones, which is used by an employee named Bert. Bert's digital identity as an employee is represented in FIG. 17 as a pie chart. Each slice in the pie chart is a partition or persona. Bert may have other digital identities relating to his home, family and private life, but, in this example, his digital identity for the Company is restricted to data, files, content and information that pertains only to the business of the Company and to his duties as an employee.

Since the Manager has access to all of Bert's partitions, all of Bert's data, files, content and information that relates to the Company is always instantly available to the Manager. As an example, the Manager may enter Bert's partition for “Assignments,” and then may change tasks assigned to Bert. Bert may submit reports to the Manager simply by updating his appropriate partition. Bert's interactions with customers, suppliers, vendors and co-workers may all be logged in appropriate partitions.

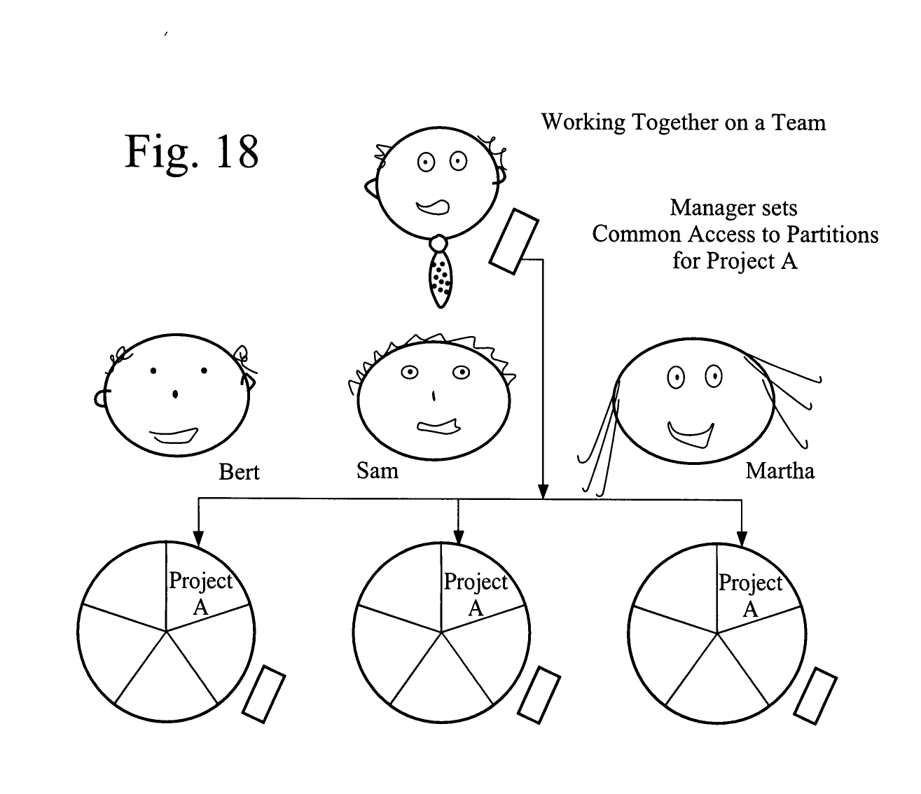

When the Manager needs Bert to work with two other employees, Sam and Martha, the Manager may link specific partitions on the smart phones operated by Bert, Sam and Martha, so that they may cooperate in a join effort, as shown in FIG. 18.

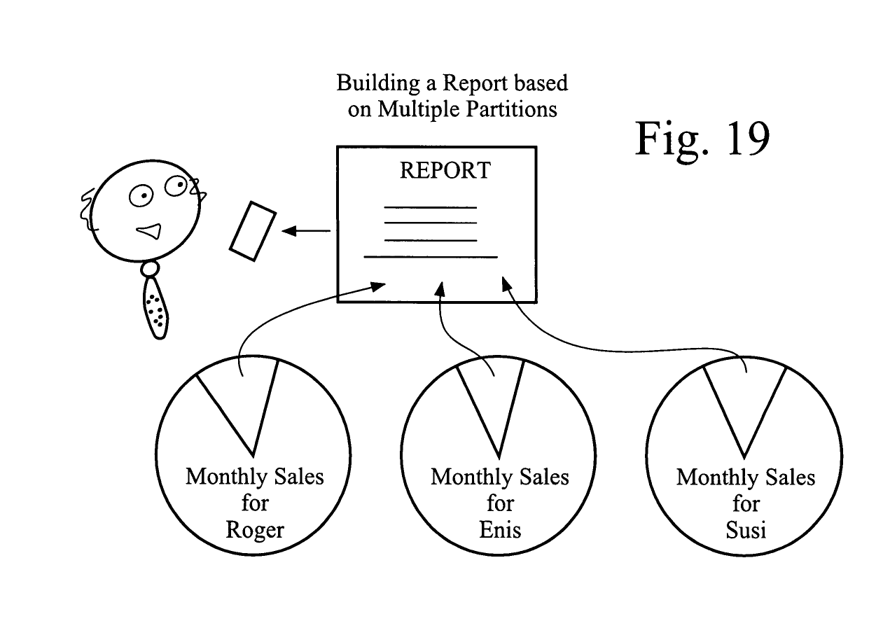

The as appointed Company Group Administrator, Manager may “drill down” through the partitions and sub-partitions of each employee to obtain information, analyze performance and to publish or to broadcast goals or requirements to each employee. As an example, each employee may have a partition named “Work Schedule” or “Travel Expenses.” The Manager may easily access all of these partitions, and may instantly process the contents of these related partitions into a spreadsheet or database to create a report for the entire Company on one of these topics. The method of generating a report based on the content of multiple partitions is displayed in FIG. 19.

The present invention enables these methods of viewing and managing digital identities and personas because the entire digital identity of each user is contained in one hardware device that is operated by each user. This containment of a user's digital identity in one place allows the Company's Group Administrator to easily and to effectively manage the Company's digital activities.

### VIII. Secure Communications

All communications to and/or from the smart phone may be protected with security systems which thwart or eliminate fraud or misuse. A conventional product, such as RSA's PGP, may be used. In one embodiment of the invention, a communication safeguard means is provided by the UltraSecure^{SM} System. The UltraSecure^{SM} System is described in U.S. patent application Ser. No. 09/887,570, filed on 22 Jun. 2001, and in PCT International Patent Application No. PCT/GB02/05612, filed on 11 Dec. 2002. Both of these Published Patent Applications are hereby incorporated by reference.

### Bilateral and Multilateral UltraSecure

In one embodiment of the invention, the UltraSecure^{SM} System comprises a Server-side software acting as encryption for source content and a Client-side software acting as the decryption and re-assembler of the content. Two (Bilateral) or more (Multilateral) devices may be entwined with a dual asynchronous communication path wherein both the Client and Server side portions of the software are installed and registered for both devices (whether in a Ops Center or a Field/Consumer device). Such entwinement enables the use of the UltraSecure Transaction Protocol (USTP) to provide the highest level of communication, content and session security between the two devices, to fully protect data on the device, data in being transferred, data in the host, or data backups being transferred over non USTP protocol systems. Applications include secure two-way communication, remote computing and backups, network transactions (email, web, fund transfers, etc), and access to secured resources (facilities, data information, etc).

### IX. Products & Users

In an alternative embodiment, features of the invention which have been described and illustrated as hardware may be reduced to software, and provided as a web service.

The present invention may be embodied in several versions of product, including, but not limited to:

Institutional

Personal

Minor (in the family context)

Minor student

Adult student

The Institutional version may include a personal partition. This is for the convenience of the user, who doesn't have to carry a separate laptop. As in a corporate laptop, the institution owns the device and all of its contents, so there is no expectation of privacy in the personal partition. The user may own and carry a separate smart phone for his own purposes. This second, personally owned smart phone may be configured by its owner so that it is not accessible by his institution. The institution's smart phone is automatically backed up on the institution's server, and the personal product is backed up by the user's home device, by various means.

The present invention may also include “Dynamic Partitioning,” in which a partition may be created by the device's owner to permit access by certain individuals or classes of individuals. Among other things, this makes the current levels of clearance obsolete, since it establishes a continuum of access which may be changed by the institution to allow access on a case-by-case basis. If the user is the owner, he may set up different partitions for different family members, groups of family members, colleagues, etc. These are not partitions in the sense the word is usually used, to refer to separate areas of a hard disc running, for example, different operating systems, but areas of storage and activity memory which can expand and contract as needed, but which are inaccessible from other partitions in memory. These partitions are accessible by the user with biometric and password identification. When he is using them, he may communicate only with permitted others who have similar identification.

The Dynamic Partitions in the Industrial model may be installed remotely by the person calling a meeting, session or establishing a project; or by the supervisor of a work group or department. In one example, he would request his server to set up partitions for Tom, Dick and Harry on their devices for a period of time, to inform them of the time of the meeting, or the existence of the project and provide them with passwords for that partition. The password distribution would be through an encrypted link such as UltraSecure, and would be available only to the particular user.

This is an automatic process performed by the server, which would automatically remove the partition when it is no longer useful. From the users' points of view, someone called a meeting or established a project and gave them the passwords to access it. Other than the simple process of placing an order on the server, the whole process requires no human intervention. The partition is made out of “rubber,” and expands and contracts to fit the data contained therein. When the transaction or project is over, it disappears along with its contents.

As an example, an institutional customer may provide smart phones to employees. The institution or each employee would create his or her own Dynamic Partitions, eliminating the need for each employee to move company files to other computers. Each partition would, for example, have different rules about printing and file transfer, along with the other constraints and controls, such as biometric and unique-to-the-partition password access.

Dynamic Partitioning may be supported via meta data logic (including search logic) that brings up a side bar. This side bar would suggest access to various partitions and the files stored within them, such as, project alpha, boy scout troop, personal finance, my medical record, etc.

### X. Additional Features

Additional features of the present invention are illustrated and described in Appendix A, which includes pages numbered A1 through A28.

### SCOPE OF THE CLAIMS

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives for providing a Remote Control App for Smart Phones that have been disclosed above are intended to educate the reader about preferred embodiments of the invention, and are not intended to constrain the limits of the invention or the scope of Claims.

What is claimed is:

1. A method for adding computing functionality to a smart phone comprising the steps of:
providing a smart phone;
said smart phone including a CPU;
said smart phone including a non-volatile memory;
said non-volatile memory being divided into a plurality of dynamic partitions;
each of said plurality of dynamic partitions being assigned to a persona;
each of said plurality of dynamic partitions being safeguarded by an access rule;
said smart phone including a volatile memory;
said smart phone including a long range radio;
said smart phone including a short range radio;
providing a transmitter;
providing a server;
said transmitter being connected to said server;
said server including a memory for storing an App;
conveying said App from said server to said transmitter;
conveying said App from said transmitter to said smart phone using said long range radio in said smart phone;
storing said App in said non-volatile memory of said smart phone;
running said App on said CPU; and
downloading said App to a nearby separate information appliance;
using said smart phone to control the function of said nearby information appliance using said short range radio.
